(19) United States
(12) Patent Application Publication
(10) Pub. No.: US 2026/0018596 A1
(43) Pub. Date: Jan. 15, 2026

(54) CATHODE ACTIVE MATERIAL FOR LITHIUM SECONDARY BATTERY INCLUDING SULFURIZED COATING LAYER AND METHOD OF MANUFACTURING SAME

(71) Applicants: Hyundai Motor Company, Seoul (KR); Kia Corporation, Seoul (KR); Kyonggi University Industry & Academia Cooperation Foundation, Suwon (KR)

(72) Inventors: Je Sik Park, Hwaseong (KR); Hong Seok Min, Hwaseong (KR); Jeong Hyun Seo, Hwaseong (KR); Im Sul Seo, Hwaseong (KR); Chung Bum Lim, Hwaseong (KR); Yong Seok Lee, Hwaseong (KR); Ju Yeong Seong, Hwaseong (KR); Joo Young Lee, Hwaseong (KR); Yong Joon Park, Seoul (KR); Dae Ik Jang, Gimcheon (KR); Ha Young Ko, Suwon (KR); Su Hyun Kwak, Seoul (KR); Da Eun Kim, Ansan-Gyeonggi-do (KR)

(21) Appl. No.: 18/970,670

(22) Filed: Dec. 5, 2024

(30) Foreign Application Priority Data
Jul. 9, 2024 (KR) 10-2024-0090355

(51) Int. Cl. H01M 4/36; H01M 4/505; H01M 4/525

(52) U.S. Cl. CPC H01M 4/366; H01M 4/505; H01M 4/525

(57) ABSTRACT

A cathode active material for a lithium secondary battery includes a core component comprising a lithium transition metal oxide and a sulfurized coating layer to enhance lithium-ion conductivity and cycle life. The coating layer may include a sulfur component and may be structured with a dual-layer configuration, where a first layer of alkali metal oxide is applied on the core component and a second sulfurized layer is disposed on the first layer. Methods for manufacturing the cathode active material involve forming a coating layer using vapor deposition or heat-treating a mixture of the core component and sulfur precursors, creating a uniform, thin sulfurized layer. This structure mitigates side reactions with sulfide-based solid electrolytes, resulting in improved coulombic efficiency, rate performance, and stability.

### CROSS-REFERENCE TO RELATED APPLICATION

This application claims, under 35 U.S.C. § 119 (a), the benefit of Korean Patent Application No. 10-2024-0090355, filed on Jul. 9, 2024, the entire contents of which are incorporated herein by reference.

### BACKGROUND

### Technical Field

The present disclosure relates to a cathode active material for a lithium secondary battery including a sulfurized coating layer and a method of manufacturing the same.

### Background

All-solid-state secondary batteries using inorganic solid electrolytes are currently the most promising next-generation secondary battery system. In particular, sulfide-based solid electrolytes, which exhibit high lithium-ion conductivity and excellent bonding properties with electrode materials, are nearing commercialization.

However, a sulfide-based solid electrolyte can cause undesired reactions with a cathode active material that is an oxide, leading to the formation of side reaction products at the interface. These side reaction products increase resistance and are a primary cause of the deterioration of the electrochemical properties in all-solid-state secondary batteries.

To address this issue, a method involves coating the surface of the cathode active material with a material that is stable in the sulfide-based solid electrolyte. Common examples of such a coating material include oxides such as Li₂ZrO₃, LiNbO₃, LiTaO₃, etc., and phosphates such as Li₃PO₄, etc. This coating material can significantly reduce side reaction between the cathode active material and the sulfide-based solid electrolyte. However, since the coating material is also an oxide similar to the cathode active material, it has limited compatibility with the sulfide-based solid electrolyte, making long-term stable contact challenging.

To address the contact issue between the coating material and the sulfide-based solid electrolyte, another method of additionally applying a sulfide-based solid electrolyte onto the coating material. This is done by dissolving the sulfide-based solid electrolyte in an organic solvent to form a liquid, which is then applied onto the coating material. However, this approach has drawbacks: the lithium ion conductivity of the sulfide-based solid electrolyte is significantly reduced during dissolution in the organic solvent, causing the additional coating layer to act as a new resistance layer. Moreover, forming the sulfide-based solid electrolyte into a liquid and applying it evenly is challenging.

### SUMMARY OF THE DISCLOSURE

Therefore, an object of the present disclosure is to provide a cathode active material for a lithium secondary battery including a sulfurized coating layer that may alleviate side reaction between a cathode active material and a sulfide-based solid electrolyte, and a method of manufacturing the same.

Another object of the present disclosure is to provide a cathode active material for a lithium secondary battery including a sulfurized coating layer that is highly compatible with a sulfide-based solid electrolyte and may be used stably for a long time, and a method of manufacturing the same.

The objects of the present disclosure are not limited to the foregoing. The objects of the present disclosure will be able to be clearly understood through the following description and to be realized by the means described in the claims and combinations thereof.

An embodiment of the present disclosure provides a cathode active material for a lithium secondary battery, including a core component including a lithium transition metal oxide and a coating layer disposed on the core component, in which the coating layer may include a sulfur component.

The coating layer may include a first layer disposed on the core component and including an alkali metal oxide and a second layer disposed on the first layer and including a sulfur component.

The alkali metal oxide may include a compound represented by Chemical Formula 1 below.

LiₐM_{b}O_{(a+c)/2} [Chemical Formula 1]

In Chemical Formula 1, M may include at least one selected from the group consisting of niobium (Nb), boron (B), phosphorus (P), tungsten (W), titanium (Ti), tantalum (Ta), tin (Sn), zirconium (Zr), and combinations thereof, a and b may satisfy 1≤a≤10 and 1≤b≤10, and c may be an oxidation number of M.

The sulfur component may include an anion containing sulfur and a cation.

The anion may include at least one selected from the group consisting of S⁻, HS⁻, SO⁻, SO₂⁻, SO₃⁻, and combinations thereof.

The cation may include at least one selected from the group consisting of lithium (Li), nickel (Ni), cobalt (Co), manganese (Mn), and combinations thereof.

The cation may include at least one selected from the group consisting of lithium (Li), nickel (Ni), cobalt (Co), manganese (Mn), niobium (Nb), boron (B), phosphorus (P), tungsten (W), titanium (Ti), tantalum (Ta), tin (Sn), zirconium (Zr), and combinations thereof.

The coating layer may further include at least one selected from the group consisting of Li₂CO₃, LiOH, and combinations thereof.

The cathode active material may show a peak at a binding energy of about 165 eV to 168 eV in an XPS spectrum of S2p obtained by X-ray photoelectron spectroscopy (XPS).

Another embodiment of the present disclosure provides a cathode active material for a lithium secondary battery. The cathode active material includes a core component comprising a lithium transition metal oxide; a first layer disposed on the core, comprising an alkali metal oxide represented by LiaMbO(a+c)/2, where M is at least one element selected from the group consisting of niobium (Nb), boron (B), phosphorus (P), tungsten (W), titanium (Ti), tantalum (Ta), tin (Sn), zirconium (Zr), and combinations thereof, and wherein a and b satisfy 1≤a≤10 and 1≤b≤10, and c is the oxidation number of M; and a second layer disposed on the first layer, comprising a sulfur component, wherein the sulfur component in the coating layer comprises an anion selected from the group consisting of S⁻, HS⁻, SO⁻, SO₂⁻, SO₃⁻, and combinations thereof, and a cation selected from the group consisting of lithium (Li), nickel (Ni), cobalt (Co), manganese (Mn), iron (Fe), aluminum (Al), and combinations thereof.

Another embodiment of the present disclosure provides a method of manufacturing a cathode active material for a lithium secondary battery, including preparing a core component including a lithium transition metal oxide and forming a coating layer on the core.

Forming the coating layer may include preparing a mixture including the core and a precursor of a sulfur component, and forming a coating layer on the core by heat-treating the mixture.

Forming the coating layer may include obtaining an intermediate by forming a first layer including an alkali metal oxide on the core component, preparing a mixture including the intermediate and a precursor of a sulfur component, and forming a second layer disposed on the first layer and including the sulfur component by heat-treating the mixture.

The precursor of the sulfur component may include at least one selected from the group consisting of sulfur, MₓS_{y}, MₓSO₄ (in which x is an integer from 1 to 3, y is an integer from 1 to 10, and M is at least one metal selected from the group consisting of Li, Na, K, Mg, Ca, and combinations thereof), and combinations thereof.

Forming the coating layer may include using a vapor deposition process to sulfurize the core component, thereby forming a uniform, thin sulfurized layer. The mixture may include about 0.01 parts by weight to 2 parts by weight of the precursor of the sulfur component based on 100 parts by weight of the core.

As discussed, the method and system suitably include use of a controller or processer.

The terms “core” and “core component” may be used interchangeably herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a lithium secondary battery according to the present disclosure;

FIG. 2 shows a cathode active material according to a first embodiment of the present disclosure;

FIG. 3 shows a cathode active material according to a second embodiment of the present disclosure;

FIG. 4 shows initial discharge curves of all-solid-state batteries including cathode active materials according to Example 1 and Comparative Example 1;

FIG. 5 shows rate characteristics of the all-solid-state batteries including the cathode active materials according to Example 1 and Comparative Example 1;

FIG. 6 shows results of evaluation of the lifespan of the all-solid-state batteries including the cathode active materials according to Example 1 and Comparative Example 1;

FIG. 7 shows a Nyquist plot of the cathode active material according to Example 1;

FIG. 8 shows a Nyquist plot of the cathode active material according to Comparative Example 1;

FIG. 9 shows initial discharge curves of all-solid-state batteries including cathode active materials according to Examples 1 and 2 and Comparative Examples 1 and 2;

FIG. 10 shows rate characteristics of the all-solid-state batteries including the cathode active materials according to Examples 1 and 2 and Comparative Examples 1 and 2;

FIG. 11 shows results of evaluation of the lifespan of the all-solid-state batteries including the cathode active materials according to Examples 1 and 2 and Comparative Examples 1 and 2;

FIG. 12 shows a cross-section of the cathode active material according to Comparative Example 1 analyzed using a transmission electron microscope (TEM);

FIG. 13 shows a cross-section of the cathode active material according to Example 1 analyzed using TEM;

FIG. 14 shows a cross-section of the cathode active material according to Comparative Example 2 analyzed using TEM;

FIG. 15 shows a cross-section of the cathode active material according to Example 2 analyzed using TEM;

FIG. 16 shows results of X-ray photoelectron spectroscopy (XPS) of the cathode active material after disassembly of the all-solid-state battery including the cathode active material according to Comparative Example 1 before charging and discharging;

FIG. 17 shows results of XPS of the cathode active material after 300 charging and discharging cycles of the all-solid-state battery including the cathode active material according to Comparative Example 1;

FIG. 18 shows results of XPS of the cathode active material after 300 charging and discharging cycles of the all-solid-state battery including the cathode active material according to Example 1;

FIG. 19 shows results of XPS of the cathode active material after 300 charging and discharging cycles of the all-solid-state battery including the cathode active material according to Comparative Example 2;

FIG. 20 shows results of XPS of the cathode active material after 300 charging and discharging cycles of the all-solid-state battery including the cathode active material according to Example 2;

FIG. 21 shows results of XPS of the cathode active material according to Comparative Example 1 with different etching times;

FIG. 22 shows results of XPS of the cathode active material according to Example 1 with different etching times;

FIG. 23 shows results of XPS of the cathode active material according to Comparative Example 2 with different etching times; and

FIG. 24 shows results of XPS of the cathode active material according to Example 2 with different etching times.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein.

The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous and includes all values from the minimum value of said range to the maximum value thereof, unless otherwise indicated. Moreover, when such a range pertains to integer values, all integers including the minimum value to the maximum value are included, unless otherwise indicated.

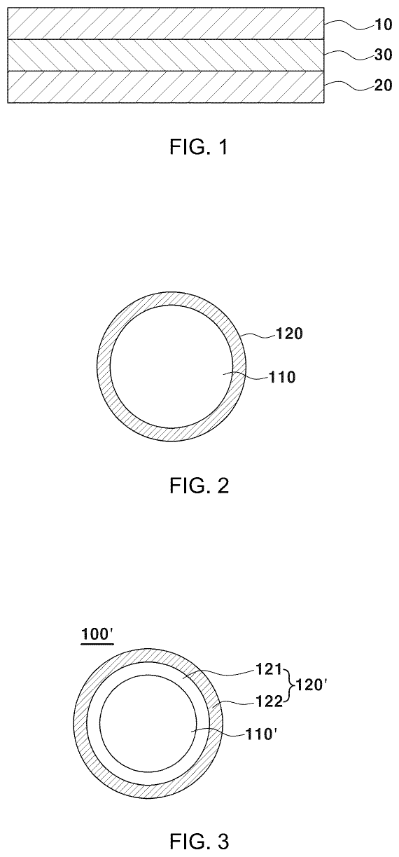

FIG. 1 shows a lithium secondary battery according to the present disclosure. The lithium secondary battery may include an all-solid-state battery. The lithium secondary battery may include a cathode 10, an anode 20, and a solid electrolyte layer 30 interposed between the cathode 10 and the anode 20.

The cathode 10 may include a cathode active material, a sulfide-based solid electrolyte, a binder, a conductive material, etc.

FIG. 2 shows a cathode active material 100 according to a first embodiment of the present disclosure. The cathode active material 100 may include a core 110 including a lithium transition metal oxide and a coating layer 120 covering the core 110.

The coating layer 120 according to the present disclosure is sulfurized and is in the form of a structure close to a sulfide. The cathode active material according to the present disclosure has a gradual chemical potential for lithium ions (Li⁺) from the core 110 to the external sulfide-based solid electrolyte, thereby preventing a rapid change in the concentration of lithium ions (Li⁺). Briefly, a non-uniform lithium ion (Li⁺) concentration layer may not be formed in the cathode 10 according to the present disclosure. Thereby, lithium ions may move efficiently at the interface between the cathode active material 100 and the sulfide-based solid electrolyte. This may lead to an increase in Coulombic efficiency and improvement in high-rate characteristics, making it possible to achieve fast charging and discharging and improve cycle characteristics.

The core 110 may include a lithium transition metal oxide that intercalates and deintercalates lithium.

The lithium transition metal oxide may include any material that is common in the art to which the present disclosure pertains. For example, the lithium transition metal oxide may include LiNiₓ₁Coₓ₂Mnₓ₃O₂ (0.65≤x1≤0.85, 0.05<x2<0.25, 0.03<x3<0.2, and x1+x2+x3=1), LiFePO₄, LiNiCAlO₂, LiCoO₂, LiMn₂O₄, LiFe_{1-y}Mn_{y}O₂ (0<y<1), etc.

The core 110 may be in the form of a secondary particle in which primary particles including the lithium transition metal oxide are aggregated. Here, the term “primary particle” may refer to the smallest particle unit that is distinguished as one lump when a cross-section of the core 110 is observed using a device such as a scanning electron microscope (SEM). The primary particle may be composed of a single grain or a plurality of grains. Also, the term “secondary particle” may refer to a structural body formed by aggregating a plurality of primary particles. The shape of the secondary particle is not particularly limited, and may be, for example, spherical or oval.

The average particle diameter (D50) of the core 110 is not particularly limited and may be, for example, about 1 μm to 20 μm. The average particle diameter (D50) of the core 110 may be measured using a commercially available laser diffraction scattering-type particle size distribution analyzer, for example, a Microtrac particle size distribution analyzer. Alternatively, 200 particles may be randomly extracted from the electron micrograph and the average particle diameter thereof may be calculated.

The coating layer 120, which is sulfurized, may include a sulfur component. A method of sulfurizing the coating layer 120 will be described later.

The sulfur component may include an anion containing sulfur and a cation. The sulfur component may include a compound in which the anion and the cation are ionically bonded.

The anion may include at least one selected from the group consisting of S⁻, HS⁻, SO⁻, SO₂⁻, SO₃⁻, and combinations thereof.

The cation may include at least one selected from the group consisting of lithium (Li), nickel (Ni), cobalt (Co), manganese (Mn), Iron (Fe), aluminum (Al) and combinations thereof. The cation may be a cation of an element derived from the core 110.

The coating layer 120 may further include at least one selected from the group consisting of Li₂CO₃, LiOH, and combinations thereof. These may be byproducts formed when manufacturing the coating layer 120. Therefore, the amount thereof may be very small and may be about 100 ppm or less based on the total weight of the cathode active material 100.

FIG. 3 shows a cathode active material 100′ according to a second embodiment of the present disclosure. The cathode active material 100′ may include a core 110′ and a coating layer 120′ covering the core 110′. The coating layer 120′ may include a first layer 121 disposed on the core 110′ and including an alkali metal oxide and a second layer 122 disposed on the first layer 121 and including a sulfur component.

Since the core 110′ is the same as in the first embodiment described above, a description thereof will be omitted below.

The alkali metal oxide of the first layer 121 may include a compound represented by Chemical Formula 1 below.

LiₐM_{b}O_{(a+c)/2} [Chemical Formula 1]

In Chemical Formula 1, M may include at least one selected from the group consisting of niobium (Nb), boron (B), phosphorus (P), tungsten (W), titanium (Ti), tantalum (Ta), tin (Sn), zirconium (Zr), and combinations thereof, a and b may satisfy 1≤a≤10 and 1≤b≤10, and c may be the oxidation number of M.

Specific examples of the alkali metal oxide may include LiNbO₃, LiBO₂, Li₃PO₄, and the like.

Since the second layer 122 is the same as the coating layer 120 according to the first embodiment described above, a description thereof will be omitted below. However, when the second layer 122 including the sulfur component is formed on the first layer 121, the cation of the sulfur component may be an element M derived from the first layer 121 in addition to lithium (Li), nickel (Ni), cobalt (Co), manganese (Mn), Iron (Fe), or aluminum (Al) derived from the core 110′. For example, the cation may include at least one selected from the group consisting of lithium (Li), nickel (Ni), cobalt (Co), manganese (Mn), Iron (Fe), aluminum (Al), niobium (Nb), boron (B), phosphorus (P), tungsten (W), titanium (Ti), tantalum (Ta), tin (Sn), zirconium (Zr), and combinations thereof.

A method of manufacturing the cathode active material according to the present disclosure may include preparing a core including a lithium transition metal oxide and forming a coating layer on the core.

In the method of manufacturing the cathode active material 100 according to the first embodiment described above, forming the coating layer may include preparing a mixture including the core and a precursor of a sulfur component and forming a coating layer covering the core by heat-treating the mixture.

In the method of manufacturing the cathode active material 100′ according to the second embodiment described above, forming the coating layer may include obtaining an intermediate by forming a first layer including an alkali metal oxide on the core, preparing a mixture including the intermediate and a precursor of a sulfur component, and forming a second layer disposed on the first layer and including the sulfur component by heat-treating the mixture.

In the present disclosure, forming the coating layer or the second layer by sulfurizing the core or the intermediate may be performed using a vapor deposition process. After mixing the core or the intermediate with the precursor of the sulfur component, the precursor of the sulfur component may be vaporized by heat treatment to form sulfur gas, which may then be reacted with the surface of the core or the intermediate. As such, the surface or outer portion of the core or the intermediate may be sulfurized. In the present disclosure using a vapor deposition process, a very uniform thin coating layer may be formed.

The thickness of the coating layer may be adjusted by the amount of the precursor of the sulfur component, and heat treatment temperature and time.

The precursor of the sulfur component may include at least one selected from the group consisting of sulfur, MₓS_{y}, MₓSO₄, and combinations thereof. In MₓS_{y} and MₓSO₄, x may be an integer from 1 to 3, y may be an integer from 1 to 10, and M may be at least one metal selected from the group consisting of Li, Na, K, Mg, Ca, and combinations thereof.

The mixture may include about 0.01 parts by weight to 2 parts by weight of the precursor of the sulfur component based on 100 parts by weight of the core. If the amount of the precursor of the sulfur component is less than 0.01 parts by weight, it may be difficult to sufficiently form the coating layer. On the other hand, if the amount of the precursor of the sulfur component exceeds 2 parts by weight, the coating layer may become thick and lithium-ion conductivity may decrease.

The method, temperature, and time of heat treatment are not particularly limited, and heat treatment may be performed using any device under any conditions so long as the precursor of elemental sulfur is sufficiently vaporized to form a coating layer.

A better understanding of the present disclosure may be obtained through the following examples. These examples are merely set forth to illustrate the present disclosure and are not to be construed as limiting the scope of the present disclosure.

### Example 1

A fine sulfur powder was obtained by pulverizing solid sulfur (purity: 99.998%). A mixture was obtained by mixing the sulfur powder and a core at about 30 Hz for about 3 minutes using a mixer mill (Hz mixer). As the core, NCM 811 (LiNi_{0.8}Mn_{0.1}Co_{0.1}O₂) was used. 100 parts by weight of the core and 0.1 parts by weight of the sulfur powder were used.

The mixture was placed in a sealed tube in an argon atmosphere and heat-treated at about 300° C. for about 4 hours so that the surface of the core was sulfurized, thereby obtaining a cathode active material including the core and a coating layer covering the core and including a sulfur component.

### Comparative Example 1

The core of Example 1 was used as a cathode active material.

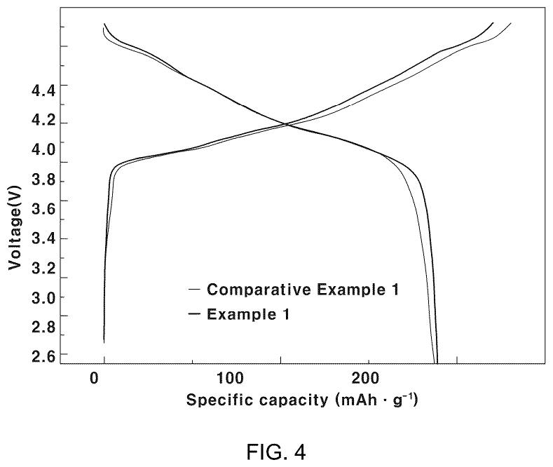

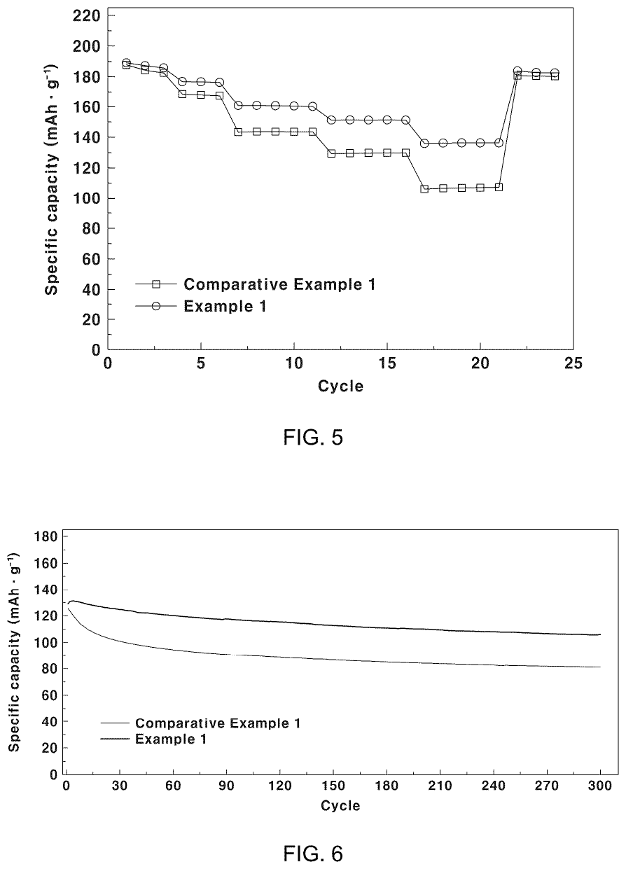

FIG. 4 shows initial discharge curves of all-solid-state batteries including the cathode active materials according to Example 1 and Comparative Example 1. FIG. 5 shows rate characteristics of the all-solid-state batteries including the cathode active materials according to Example 1 and Comparative Example 1. Referring thereto, Example 1 and Comparative Example 1 had similar initial capacities, but Example 1 was superior in rate characteristics.

FIG. 6 shows results of evaluation of the lifespan of the all-solid-state batteries including the cathode active materials according to Example 1 and Comparative Example 1. Example 1 exhibited vastly superior lifespan characteristics compared to Comparative Example 1.

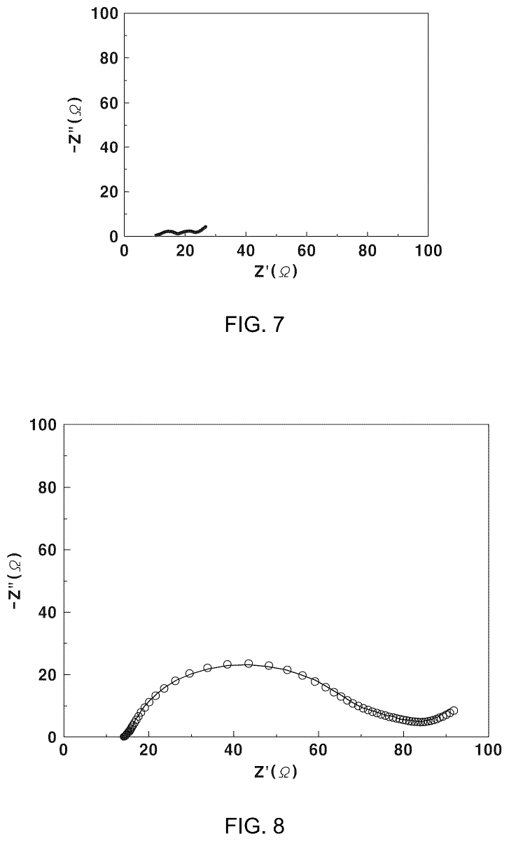

FIG. 7 shows a Nyquist plot of the cathode active material according to Example 1. FIG. 8 shows a Nyquist plot of the cathode active material according to Comparative Example 1. These are results after 300 charging and discharging cycles of the all-solid-state batteries including respective cathode active materials. Referring thereto, the resistance component of Example 1 was much smaller. This means that Example 1 has low resistance to the movement of lithium ions.

### Example 2

A coating solution was obtained by dissolving lithium ethoxide and polyphosphoric acid in an alcohol solvent. A core was added to the coating solution. As the core, NCM 811 (LiNi_{0.8}Mn_{0.1}Co_{0.1}O₂) was used. The core was used in an amount of about 3 g, the alcohol solvent was used in an amount of about 30 ml, and lithium ethoxide and polyphosphoric acid were used in amounts of about 0.15 parts by weight based on 100 parts by weight of the core. Thereafter, the solvent was evaporated with stirring at about 70° C. After completely evaporating the remaining solvent in a vacuum oven, heat treatment was performed at about 400° C. for about 1 hour, obtaining an intermediate in which the core was coated with Li₃PO₄.

A fine sulfur powder was obtained by pulverizing solid sulfur (purity: 99.998%). A mixture was obtained by mixing the sulfur powder and the intermediate at about 30 Hz for about 3 minutes using a mixer mill (Hz mixer). The sulfur powder was used in an amount of 0.1 parts by weight based on 100 parts by weight of the core.

The mixture was placed in a sealed tube in an argon atmosphere and heat-treated at about 300° C. for about 4 hours so that the surface of the core was sulfurized, thereby obtaining a cathode active material including the core and a coating layer covering the core and including a sulfur component.

### Comparative Example 2

The intermediate of Example 2 was used as a cathode active material.

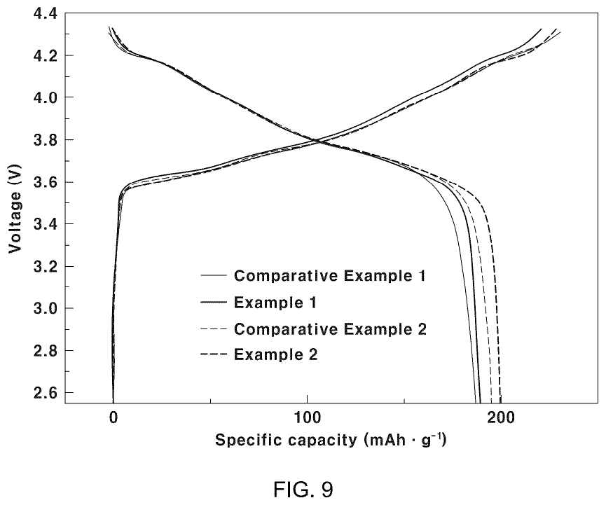

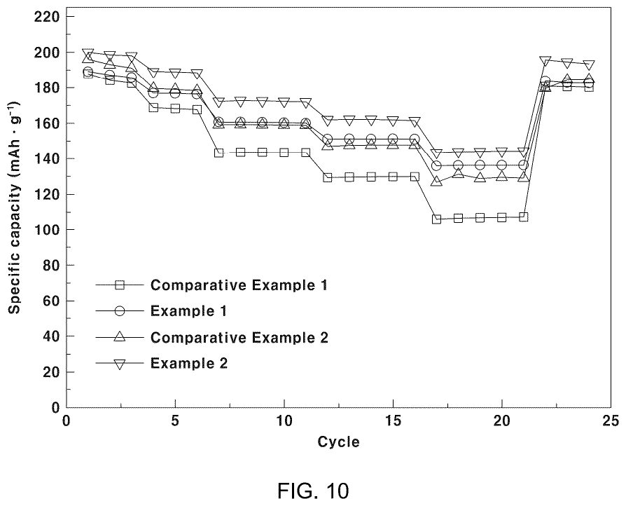

FIG. 9 shows initial discharge curves of all-solid-state batteries including the cathode active materials according to Examples 1 and 2 and Comparative Examples 1 and 2. FIG. 10 shows rate characteristics of the all-solid-state batteries including the cathode active materials according to Examples 1 and 2 and Comparative Examples 1 and 2. Referring thereto, Example 2 was superior in both initial capacity and rate characteristics compared to Comparative Example 2.

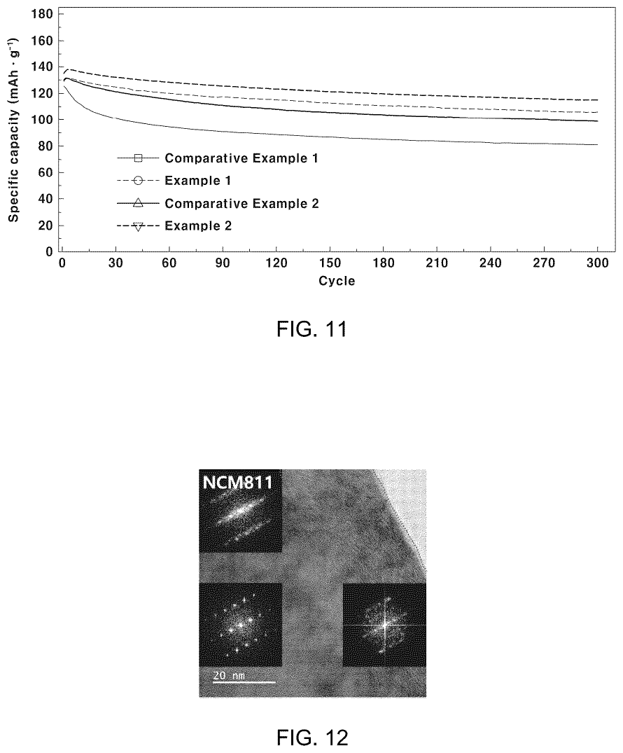

FIG. 11 shows results of evaluation of the lifespan of the all-solid-state batteries including the cathode active materials according to Examples 1 and 2 and Comparative Examples 1 and 2. Examples 1 and 2 exhibited vastly superior lifespan characteristics compared to Comparative Example 2.

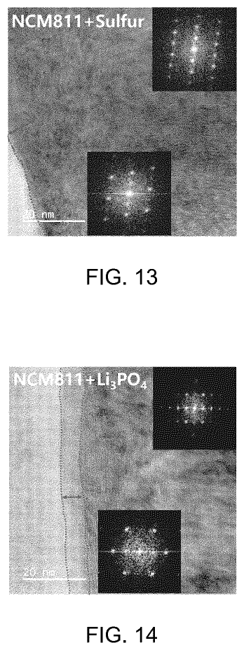

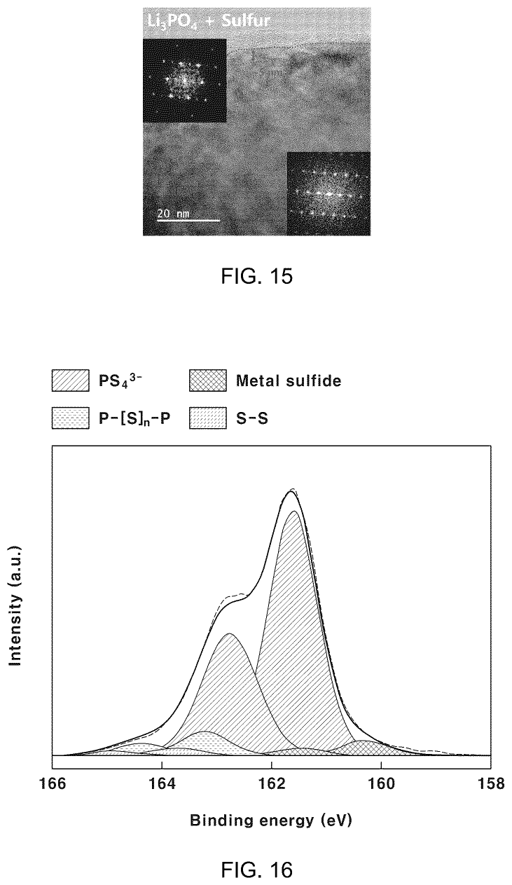

FIG. 12 shows a cross-section of the cathode active material according to Comparative Example 1 analyzed using a transmission electron microscope (TEM). FIG. 13 shows a cross-section of the cathode active material according to Example 1 analyzed using TEM. FIG. 14 shows a cross-section of the cathode active material according to Comparative Example 2 analyzed using TEM. FIG. 15 shows a cross-section of the cathode active material according to Example 2 analyzed using TEM. These are results after 300 charging and discharging cycles of the all-solid-state batteries including respective cathode active materials. Referring to FIG. 12, a side reaction layer having a thickness of about 25 nm was observed at the surface of Comparative Example 1, but referring to FIG. 13, the thickness of the side reaction layer was decreased to about 15 nm in Example 1. Meanwhile, referring to FIGS. 14 and 15, the side reaction layer of Example 2 had a thickness of about 5 nm, which is thinner than the side reaction layer of Comparative Example 2.

FIG. 16 shows results of X-ray photoelectron spectroscopy (XPS) of the cathode active material after disassembly of the all-solid-state battery including the cathode active material according to Comparative Example 1 before charging and discharging.

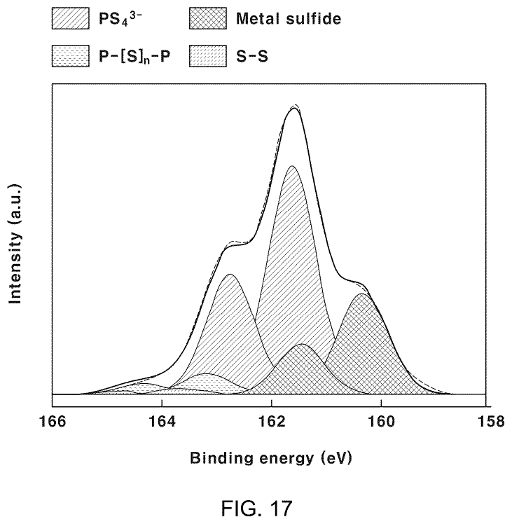

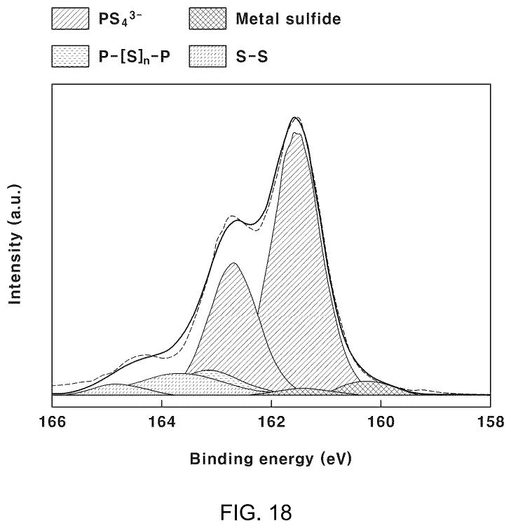

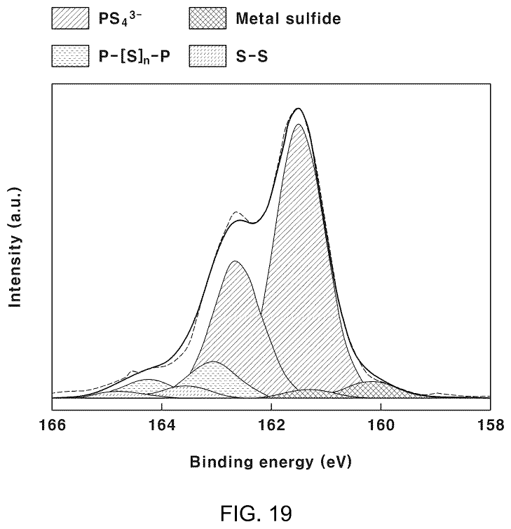

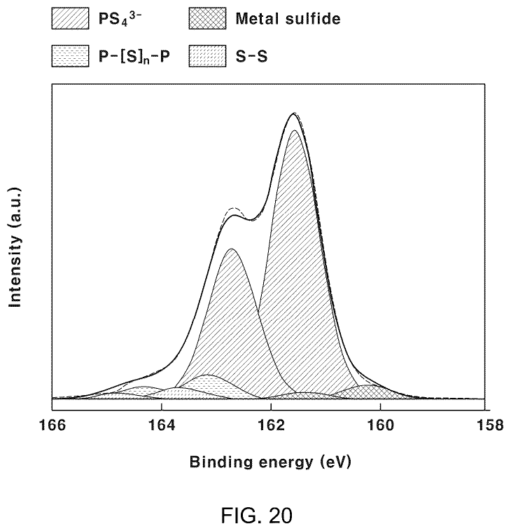

FIG. 17 shows results of XPS of the cathode active material after 300 charging and discharging cycles of the all-solid-state battery including the cathode active material according to Comparative Example 1. FIG. 18 shows results of XPS of the cathode active material after 300 charging and discharging cycles of the all-solid-state battery including the cathode active material according to Example 1. FIG. 19 shows results of XPS of the cathode active material after 300 charging and discharging cycles of the all-solid-state battery including the cathode active material according to Comparative Example 2. FIG. 20 shows results of XPS of the cathode active material after 300 charging and discharging cycles of the all-solid-state battery including the cathode active material according to Example 2. Respective results are XPS spectra of S2p.

Referring to FIG. 16, before charging and discharging, the peak of S2p observed in the sulfide-based solid electrolyte represented as PS₄³⁻ appeared clearly. Also, metal sulfide, P—[S]ₙ—P, and S—S peaks appeared weakly.

Referring to FIG. 17, in Comparative Example 1, a large peak of metal sulfide appeared after charging and discharging. Here, metal sulfide is produced by interface reaction between the cathode active material and the sulfide-based solid electrolyte, so the above results show that Comparative Example 1 has many side reaction products.

Referring to FIGS. 18 to 20, the peak intensity of metal sulfide in all of Examples 1 and 2 and Comparative Example 2 was relatively low. This means that side reaction may be significantly alleviated through surface treatment of the core.

In particular, referring to FIGS. 18 and 20, Examples 1 and 2 showed a large peak compared to Comparative Examples 1 and 2 at binding energy of 165 eV to 168 eV in the XPS spectrum of S2p obtained by X-ray photoelectron spectroscopy (XPS).

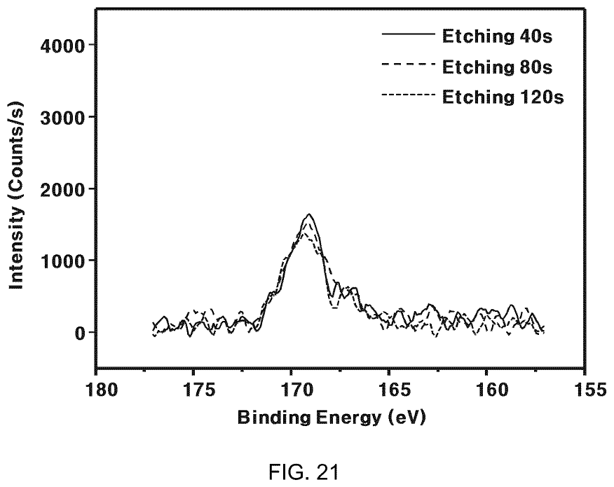

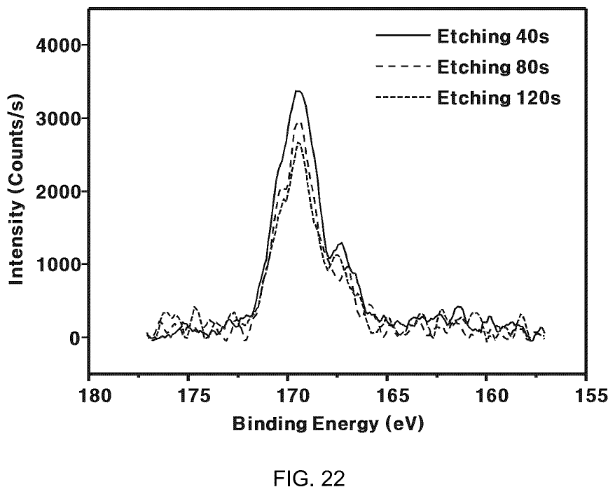

FIG. 21 shows results of XPS of the cathode active material according to Comparative Example 1 with different etching times. FIG. 22 shows results of XPS of the cathode active material according to Example 1 with different etching times. Referring thereto, the peak of S2p was clear in the cathode active material of Example 1 in which the coating layer including the sulfur component was formed by sulfurizing the surface of the core.

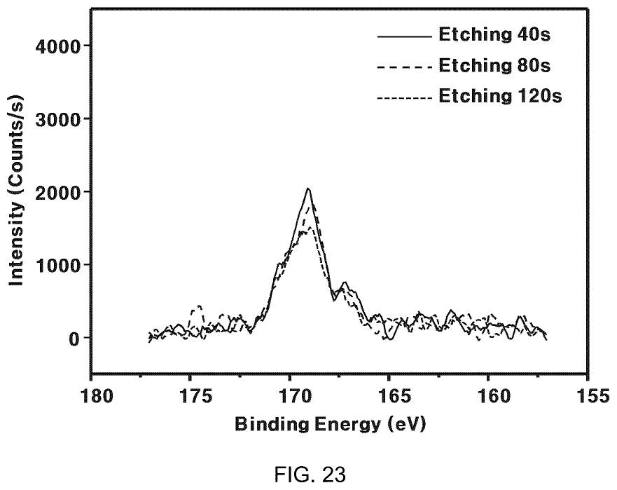

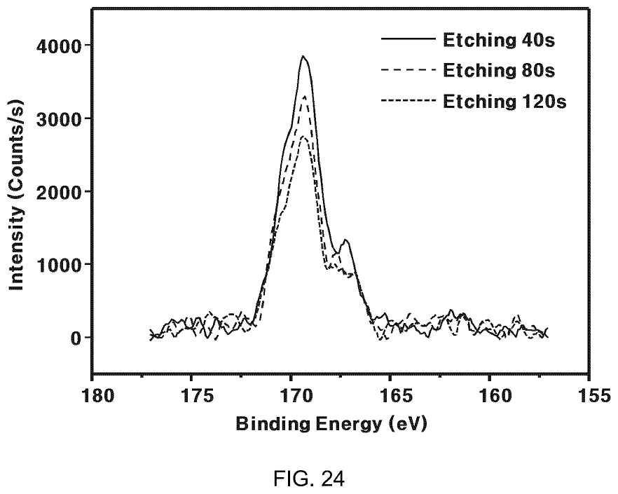

FIG. 23 shows results of XPS of the cathode active material according to Comparative Example 2 with different etching times. FIG. 24 shows results of XPS of the cathode active material according to Example 2 with different etching times. Likewise, the peak of S2p clearly appeared in the cathode active material of Example 2 in which the second layer including the sulfur component was formed.

An oxide coating layer provided to a conventional cathode active material for a lithium secondary battery alleviates side reaction to some extent at the interface with a sulfide-based solid electrolyte, but such a coating layer is an oxide and thus a chemical potential thereof for lithium ions (Li⁺) is not as high as that of sulfide, making it impossible to fundamentally prevent formation of a non-uniform lithium ion concentration layer.

On the other hand, in the cathode active material according to the present disclosure, the coating layer, which is sulfurized and includes a sulfur component, is able to prevent a rapid change in the concentration of lithium ions in the cathode, thereby controlling the formation of a non-uniform lithium-ion concentration layer as much as possible. Consequently, lithium ions may move efficiently at the interface between the cathode active material and the sulfide-based solid electrolyte, which may lead to an increase in Coulombic efficiency and improvement in high-rate characteristics.

As is apparent from the above description, according to the present disclosure, a cathode active material for a lithium secondary battery including a sulfurized coating layer capable of alleviating side reaction between a cathode active material and a sulfide-based solid electrolyte and a method of manufacturing the same are provided.

According to the present disclosure, a cathode active material for a lithium secondary battery including a sulfurized coating layer that has excellent compatibility with a sulfide-based solid electrolyte and can be used stably for a long time and a method of manufacturing the same are provided.

The effects of the present disclosure are not limited to the foregoing. It should be understood that the effects of the present disclosure include all effects that can be inferred from the description of the present disclosure.

As the examples of the present disclosure have been described in detail above, the scope of the present disclosure is not limited to the aforementioned examples, and various modifications and improvements made by those skilled in the art using the basic concept of the present disclosure defined in the following claims are also within the scope of the present disclosure.

What is claimed is:

1. A cathode active material for a lithium secondary battery, the cathode active material comprising:
a core component comprising a lithium transition metal oxide; and
a coating layer disposed on the core,
wherein the coating layer comprises a sulfur component.

2. The cathode active material of claim 1, wherein the coating layer comprises:
a first layer disposed on the core component and comprising an alkali metal oxide; and
a second layer disposed on the first layer and comprising a sulfur component.

3. The cathode active material of claim 2, wherein the alkali metal oxide comprises a compound represented by Chemical Formula 1 below:
LiₐM_{b}O_{(a+c)/2} [Chemical Formula 1]
in Chemical Formula 1, M comprises at least one selected from the group consisting of niobium (Nb), boron (B), phosphorus (P), tungsten (W), titanium (Ti), tantalum (Ta), tin (Sn), zirconium (Zr), and combinations thereof, a and b satisfy 1≤a≤10 and 1≤b≤10, and c is an oxidation number of M.

4. The cathode active material of claim 1, wherein the sulfur component comprises an anion comprising sulfur; and a cation.

5. The cathode active material of claim 4, wherein the anion comprises at least one selected from the group consisting of S⁻, HS⁻, SO⁻, SO₂⁻, SO₃⁻, and combinations thereof.

6. The cathode active material of claim 4, wherein the cation comprises at least one selected from the group consisting of lithium (Li), nickel (Ni), cobalt (Co), manganese (Mn), Iron (Fe), aluminum (Al) and combinations thereof.

7. The cathode active material of claim 2, wherein the sulfur component comprises an anion comprising sulfur; and a cation, and the cation comprises at least one selected from the group consisting of lithium (Li), nickel (Ni), cobalt (Co), manganese (Mn), Iron (Fe), aluminum (Al), niobium (Nb), boron (B), phosphorus (P), tungsten (W), titanium (Ti), tantalum (Ta), tin (Sn), zirconium (Zr), and combinations thereof.

8. The cathode active material of claim 1, wherein the cathode active material shows a peak at a binding energy of about 165 eV to 168 eV in an XPS spectrum of S2p obtained by X-ray photoelectron spectroscopy (XPS).

9. A cathode active material for a lithium secondary battery, the cathode active material comprising:
a core component comprising a lithium transition metal oxide;
a first layer disposed on the core component, comprising an alkali metal oxide represented by LiₐM_{b}O_{(a+c)/2}, where M is at least one element selected from the group consisting of niobium (Nb), boron (B), phosphorus (P), tungsten (W), titanium (Ti), tantalum (Ta), tin (Sn), zirconium (Zr), and combinations thereof, and wherein a and b satisfy 1≤a≤10 and 1≤b≤10, and c is the oxidation number of M; and
a second layer disposed on the first layer, comprising a sulfur component, wherein the sulfur component in the coating layer comprises an anion selected from the group consisting of S⁻, HS⁻, SO⁻, SO₂⁻, SO₃⁻, and combinations thereof, and a cation selected from the group consisting of lithium (Li), nickel (Ni), cobalt (Co), manganese (Mn), iron (Fe), aluminum (Al), and combinations thereof.

10. A method of manufacturing a cathode active material for a lithium secondary battery, the method comprising:
preparing a core component comprising a lithium transition metal oxide; and
forming a coating layer on the core component,
wherein the coating layer comprises a sulfur component.

11. The method of claim 10, wherein forming the coating layer comprises:
preparing a mixture comprising the core component and a precursor of the sulfur component; and
forming a coating layer on the core by heat-treating the mixture.

12. The method of claim 10, wherein forming the coating layer comprises:
obtaining an intermediate by forming a first layer comprising an alkali metal oxide on the core component;
preparing a mixture comprising the intermediate and a precursor of the sulfur component; and
forming a second layer disposed on the first layer and comprising the sulfur component by heat-treating the mixture.

13. The method of claim 11, wherein the precursor of the sulfur component comprises at least one selected from the group consisting of sulfur, MₓS_{y}, MₓSO₄ (in which x is an integer from 1 to 3, y is an integer from 1 to 10, and M is at least one metal selected from the group consisting of Li, Na, K, Mg, Ca, and combinations thereof), and combinations thereof.

14. The method of claim 11, wherein the mixture comprises about 0.01 parts by weight to 2 parts by weight of the precursor of the sulfur component based on 100 parts by weight of the core.

15. The method of claim 10, wherein the sulfur component comprises an anion comprising sulfur; and a cation.

16. The method of claim 15, wherein the anion comprises at least one selected from the group consisting of S⁻, HS⁻, SO⁻, SO₂⁻, SO₃⁻, and combinations thereof.

17. The method of claim 15, wherein the cation comprises at least one selected from the group consisting of lithium (Li), nickel (Ni), cobalt (Co), manganese (Mn), Iron (Fe), aluminum (Al) and combinations thereof.

18. The method of claim 12, wherein the sulfur component comprises an anion comprising sulfur; and a cation, and the cation comprises at least one selected from the group consisting of lithium (Li), nickel (Ni), cobalt (Co), manganese (Mn), Iron (Fe), aluminum (Al), niobium (Nb), boron (B), phosphorus (P), tungsten (W), titanium (Ti), tantalum (Ta), tin (Sn), zirconium (Zr), and combinations thereof.

19. The method of claim 10, wherein forming the coating layer comprises using a vapor deposition process to sulfurize the core component, thereby forming a uniform, thin sulfurized layer.

20. The method of claim 10, wherein the cathode active material shows a peak at a binding energy of about 165 eV to 168 eV in an XPS spectrum of S2p obtained by X-ray photoelectron spectroscopy (XPS).
